(19) United States
(12) Patent Application Publication
(10) Pub. No.: US 2005/0230959 A1
(43) Pub. Date: Oct. 20, 2005

(54) Security document with biometric or photographic image

(76) Inventor: Joshua Robert Nemeth, Victoria (AU)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/514,099

(22) PCT Filed: May 6, 2003
(86) PCT No.: PCT/AU03/00536

§ 371 Date: Nov. 9, 2004

(30) Foreign Application Priority Data
May 9, 2002 (AU) PS 2210

(51) Int. Cl. G09C 3/00

(52) U.S. Cl. 283/74

(57) ABSTRACT

A security document or token in the form of an identity card (10) is provided which incorporates a biometric or photographic image (24) provided in a transparent region or window (18) such that the image is substantially distinguishable from both sides of the card (10). Regions of partial or varying opacity (20, 30) are provided adjacent to or surround the window (18). A portion (27) of the photographic image (24) extends into at least one region of partial or varying opacity (20), and another portion (25) of the image extends into the substantially opaque region (22) surrounding the window (18) and the regions (20, 30). The portion (27) of the image which extends into the region of partial or varying opacity is at least partly visible from both sides of the document in transmission, but only visible from one side of the document in reflection. The regions of partial or varying opacity (22) and the photographic image (24) may be applied to a base support or substrate (32) in such a manner that removal of the image (24) from the substrate (32) results in removal or damage of the regions of partial or varying opacity (20, 30).

### FIELD OF THE INVENTION

The present invention relates to security documents or tokens bearing biometric or photographic images.

### BACKGROUND TO THE INVENTION

As used herein, the term “security documents or tokens” includes documents such as identity documents, value documents or entrance documents, which in turn respectively include: passports, visas, identity cards, drivers licences, and security entrance cards, banknotes, shares, bonds, certificates, cheques, lottery tickets, bank cards, charge cards and credit cards, and aeroplane tickets, bus tickets, railroad tickets, and tickets to fun parks or specific rides. These security documents or tokens typically include some form of authenticity verification to guard against copying and fraudulent alteration. The authenticity verification typically includes a magnetic strip, but may include other forms of verification such as a signature and/or a photographic image.

Identity documents and value documents such as identity cards and credit cards, are typically formed of a stiff opaque plastics card and photographic images may be provided on one side of the card. In some cases the photograph is covered with laminated plastic sheet.

In view of requirements for increasing levels of security, it is desirable to provide an alternative image bearing security document or token. It is desirable that the alternative security document or token includes an identifying image, such as a photographic or biometric image, and that a preferred form of the alternative security document includes alternative and/or additional means for preventing fraudulent replacement or alteration of the image.

### SUMMARY OF INVENTION

According to one aspect of the invention, there is provided a security document or token bearing indicia, wherein the document has a transparent region and a biometric image provided in said transparent region, wherein the biometric image is substantially distinguishable when viewed from both sides of the document or token.

The biometric image may comprise any form of image which is unique to a person, such as a fingerprint, but in a preferred form of the invention, the biometric image is a photograph of a person corresponding to the holder of the document which enables the unique facial structure of the person to be identified and distinguished from both sides of the security document or token.

According to another aspect of the present invention there is provided a security document or token bearing indicia, wherein the security document has a transparent region and a photographic image provided in said transparent region, the photographic image being substantially distinguishable when viewed from both sides of the document or token, wherein the photographic image is an image of a person's face, the image enabling the unique facial structure of the person to be identified and distinguished from both sides of the security document or token.

The security document or token may comprise, for example, any one of the following: identity documents such as passports, visas, identity cards, drivers licences, and security entrance cards, value documents such as banknotes, shares, bonds, certificates, cheques, lottery tickets, bank cards, charge cards and credit cards, and entrance documents such as aeroplane tickets, bus tickets, railroad tickets, and tickets to fun parks or specific rides.

Preferably, at least the transparent region of the security document is formed from a transparent plastics material. The security document may comprise a substantially opaque support, eg. of paper, card or opaque plastics material, which includes a transparent portion forming the transparent region or “window”. However, the security document more preferably includes a transparent substrate of plastics material which is covered with one or more opacifying layers or coatings except in the area of the transparent region or window.

In one embodiment, eg. in a security document comprising a flexible sheet such as a banknote, cheque or security paper, the transparent substrate may be covered by one or more opacifying layers of ink or other pigments. In another embodiment, the transparent substrate may be covered by layers of stiffer material, eg. to form a credit card, identity card or the like.

The substrate preferably comprises a polymeric material, and more preferably the substrate comprises at least one bi-axially orientated polymeric film, such as described in WO 83/00659, the contents of which are incorporated herein by reference.

In a preferred form, the security document has at least one region of partial or varying opacity adjacent to or surrounding the transparent region or window.

In a particularly preferred embodiment, part of the biometric or photographic image extends into said at least one region of partial or varying opacity.

According to a further aspect of the invention there is provided a security document or token bearing indicia, wherein the document or token has a transparent region, at least one region of partial or varying opacity adjacent to or surrounding the transparent region, and an image provided in the transparent region, the image being substantially distinguishable when viewed from both sides of the document or token, and the image extending into the at least one region of partial or varying opacity.

Preferably, part of the image extends beyond said transparent region to overlay a portion of at least one substantially opaque region of the document or token which is adjacent to or surrounds said transparent region, or which is adjacent to or surrounds said at least one region of partial or varying opacity.

The at least one region of partial or varying opacity is preferably provided on at least one side of the image, with at least a portion of said at least one region of partial or varying opacity being provided between the image and the surrounding opaque region.

The at least one region of partial or varying opacity is preferably provided on at least one side of the image, with at least a portion of said at least one region of partial or varying opacity being provided between the image and the surrounding opaque region.

The at least one region of partial or varying opacity may be formed by at least one partially opacifying pigment coating. In one preferred embodiment, one or more regions of varying opacity may comprise different forms of a partially opacifying pigment coating, such as described in WO 83/00659 in which the different forms having different proportions of a major portion of pigment in a minor portion of cross-linked polymeric binder, thereby providing different degrees of opacity.

Alternatively, the partially opacifying pigment coating may be variable in thickness to provide said one or more regions of varying opacity.

The region or regions of partial or varying opacity adjacent to or surrounding the transparent region enable different visual effects to be achieved when at least one part of the image extends into the region or regions of partial or varying opacity. For instance, part or parts of the image extending into a region or regions of partial opacity may be at least partly visible from both sides of the document in transmission, and visible from only the side on which the image is applied when viewed in reflection. A region of partial opacity may also be of varying opacity, for example the region may have a lesser degree of opacity adjacent to the transparent region and a greater degree of opacity adjacent to a surrounding substantially opaque region.

A photographic image may comprise an image of a person's face.

The image may comprise a digital image, e.g. a printed digital photograph.

In one preferred form of the present invention, the image may be applied directly onto the substrate, e.g. by printing. Said at least one region of partial or varying opacity may be applied to the substrate either before or after printing of the image. In one preferred form of the invention, the image is laser printed directly onto the transparent region and said one or more regions of partial or varying opacity.

In another form of the security document, the image is formed onto an imaging laminate, the imaging laminate being at least partially bonded to the substrate and said one or more regions of partial or varying opacity.

The image may be formed onto the imaging laminate by thermal transfer printing.

In a particularly preferred embodiment, the at least one region of partial or varying opacity and the image are applied to a support or substrate in such a manner that removal of the image from the support or substrate will also result in removal or damage of the at least one region of partial or varying opacity.

Preferably, the adhesion between said one or more regions of partial or varying opacity and the substrate, and the adhesion between said one or more regions of partial or varying opacity and said image is such that greater force is required to separate said one or more regions of partial or varying opacity and said image than is required to separate said one or more regions of partial or varying opacity and the substrate.

The one or more regions of partial or varying opacity may be at least partially bonded to the support or substrate. The bonding of imaging laminate and/or said one or more regions of partial or varying opacity to the support or substrate may be achieved by use of an adhesive.

Alternatively, or additionally, heat and/or pressure may be used in the bonding process.

The security document or token may include at least one security laminate provided on at least one side of the support or substrate. Preferably, the security document includes security laminates on both sides of the support or substrate which encapsulate the image and the support or substrate.

According to another aspect of the present invention there is provided a method of forming a security document or token comprising: providing a support with a transparent region, and providing a biometric or photographic image in the transparent region so that the biometric or photographic image is distinguishable when viewed from both sides of the support.

The support may comprise a substantially opaque sheet or substrate which is provided with a transparent portion of plastics material forming the transparent region or window. Preferably, the support includes a transparent substrate of plastics material which is covered with one or more opacifying layers except in the area of the transparent region or window.

Preferably, the method further comprises the step of applying the image to said support. The method preferably also includes the step of externally applying one or more regions of partial or varying opacity to the support adjacent to or surrounding the transparent region.

The step of applying one or more regions of partial or varying opacity to the support may comprise at least partially bonding said one or more regions to the support. The step of at least partially bonding said one or more regions of partial or varying opacity to said support may include application of an adhesive.

Alternatively, the step of applying one or more regions of partial or varying opacity to said support may comprise application of one or more forms of a partially opacifying pigment coating.

The partially opacifying pigment coating may be applied to different regions of said support in different thicknesses to provide said one or more regions of varying opacity.

The step of applying said image to said support may be performed before or after the step of applying one or more regions of partial or varying opacity to said support.

The image is preferably applied in such a manner as to extend partially into said one or more regions of partial or varying opacity.

According to another aspect of the invention, there is provided a method of forming a security document or token comprising the steps of providing a support with a transparent region, applying one or more regions of partial or varying opacity to the support adjacent to or surrounding the transparent region, and providing an image in the transparent region, the image being substantially distinguishable when viewed from both sides of the support, and the image extending into the at least one region of partial or varying opacity.

The step of applying the image to said support may include applying one portion of the image to said one or more regions of partial varying opacity and another portion of the image to a substantially opaque region of the support.

In one form of the method, the image is applied directly. Preferably, direct application of the image comprises printing of said image, and more preferably by laser printing.

In another form of the method, the image is applied indirectly, via an imaging laminate. The step of applying the image indirectly via the imaging laminate may include the step of thermally printing said image onto said imaging laminate.

Preferably the image and said one or more regions of partial or varying opacity are applied to the support in such a manner that removal of the image from the support results in removal or damage of at least one region of partial or varying opacity. This may be achieved by application of said one or more regions of partial or varying opacity to said support and application of said image to said one or more regions of partial or varying opacity and said support resulting in adhesion between (a) said one or more regions of partial or varying opacity and said support and (b) said one or more regions of partial or varying opacity and said image being such that greater force is required to separate said one or more regions of partial or varying opacity and said image than is required to separate said one or more regions of partial or varying opacity and said support.

The method preferably includes the step of converting said image to digital form prior to said step of providing said image in a transparent region of a support.

The method may include the steps of providing at least one security laminate on at least one side of the support. Preferably, the method includes the step of encapsulating said image and said support between security laminates on both sides of the support.

### BRIEF DESCRIPTION OF THE DRAWINGS

A preferred embodiment of the present invention will now be described, by way of example only, with reference to the following drawings in which:

FIG. 1 is a plan view of an identity card of the present invention prior to application of a biometric or photographic image;

FIG. 2 is a plan view of the identity card of FIG. 1 including a biometric or photographic image.

FIG. 3 is a plan view of an opposite side of the identity card of FIG. 2 to that shown in FIG. 2.

FIG. 4 is an exploded sectional view through A-A of FIG. 1 showing the layers forming the identify card of FIGS. 2 and 3 using one method of production which involves printing a biometric or photographic image directly onto a base substrate;

FIG. 5 is an exploded sectional view similar to FIG. 4 showing an alternative method of production; and

FIG. 6 is an exploded sectional view through A-A of FIG. 1 similar to that of FIG. 4 showing a further method of production which involves an imaging laminate.

### DESCRIPTION OF PREFERRED EMBODIMENTS

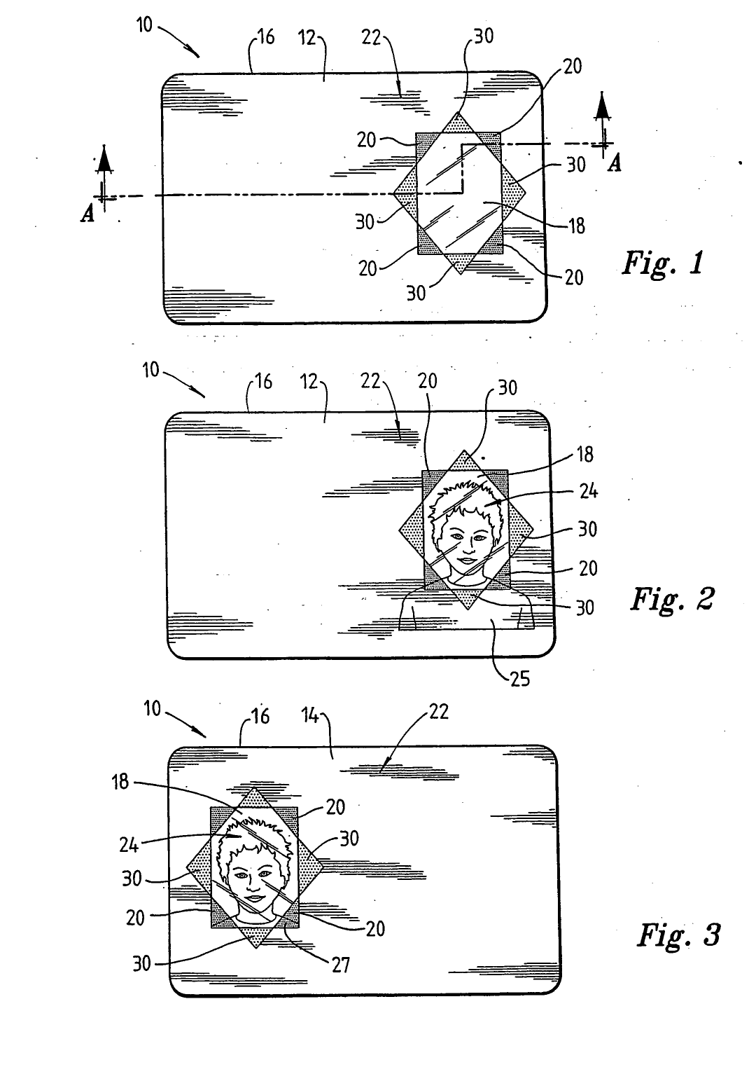

FIGS. 1-3 show an embodiment of an identity card 10 in accordance with the present invention. Specific forms of the identity card 10 bear indicia (not shown) on either or both sides 12 and 14. Features of the identity card 10 and separate processes by which it can be formed, are outlined below. It will be readily apparent to a person skilled in the relevant art that the features of the identity card 10 and processes by which it can be produced, apply to other security documents or tokens referred to previously in the present specification.

Referring to FIGS. 1-3, the identity card 10 generally comprises a plastic card 16 having a transparent region or window 18, regions of partial or varying opacity 20, 30 which are provided adjacent to the transparent window 18 so as to surround the window, and an opaque region 22 of maximum opacity which surrounds the regions of partial or varying opacity 20, 30 and covers the remainder of both sides 12 and 14 of the identity card 10. Referring to FIGS. 2 and 3, the identity card 10 also includes an image, which in the case of the identity card 10 is a biometric image in the form of a photographic image 24. As previously explained, the image can be other than a biometric and/or photographic image. The photographic image 24 is preferably an image of an upper portion of a person, including the face of the portion. The photographic image 24 is positioned on the identity card 10 so that the image of the person's face is positioned approximately centrally of the transparent window 18 with part 25 of the image 24, e.g. the person's upper torso and the background, extending outside the transparent window 18. The image of the person's face can be clearly distinguished when viewed from either side of the identity card 10 (see FIGS. 2 and 3), whereas portions 25 of the image which extend into the opaque region 22 can only be distinguished when viewed from the front side 12. A portion 27 of the photographic image 24 which extends into the regions of partial or varying opacity 20, 30, e.g. the person's shoulders, can be clearly distinguished when viewed from the front side 12 but only partially distinguished when viewed from the rear side 14 as shown in FIG. 3

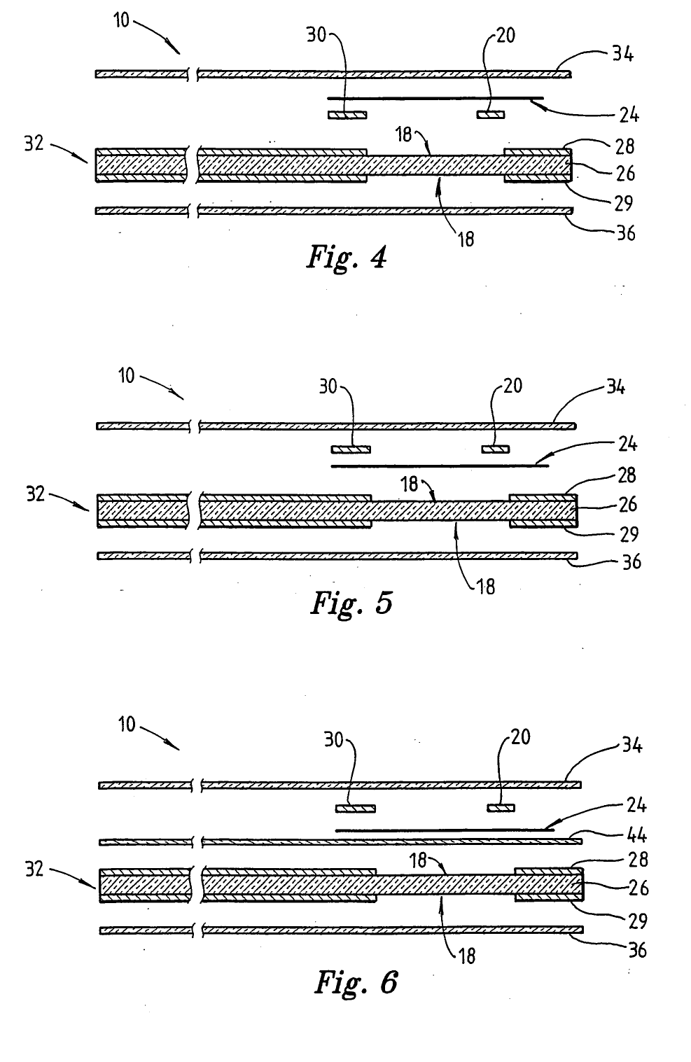

FIG. 4 illustrates one method of producing the identity card 10 from a transparent polymeric sheet 26. With the exception of a region of the transparent polymeric sheet 26 which corresponds to the transparent window 18, the transparent polymeric sheet 26 is covered on both sides by upper and lower layers of stiffer opaque plastics material 28, 29. The transparent polymeric sheet 26 and layers of stiffer opaque plastics material 28, 29 are preferably bonded together, e.g. by an adhesive, to form a base substrate 32. The opaque parts 28, 29 of the substrate 32 may be subsequently printed with designs, text and other indicia.

In the case of security documents other than, for example, identity cards or credit cards, which are not required to be stiff, the transparent polymeric sheet 26 can be covered on both sides, except in the region which corresponds to the transparent window 18, by opacifying layers of ink or other pigment coatings.

The transparent polymeric sheet 26 preferably comprises a bi-axially orientated polymeric film such as that described in WO 83/00659. The regions of partial or varying opacity 20, 30 can be applied to one side of the base substrate 32 and a digitised version of the photographic image 24 is subsequently laser printed to the same side of the base substrate 32 so that it overlays transparent window region 18 and the regions of partial or varying opacity 20, 30. The photographic image 24 may also overlie the opaque region 22 of the substrate 32 surrounding the transparent region 18 and the partial regions of partial or varying opacity. Transparent security laminates 34 and 36 are then applied, e.g. via adhesive, to both sides of the base substrate 32 to encapsulate the base substrate 32.

The regions of partial or varying opacity 20, 30 are preferably formed by applying different forms (or thicknesses) of a partially opacifying pigment coating, such as described in WO 83/00659. The different forms containing different proportions of a major portion of pigment in a minor portion of polymeric binder. The two different forms of pigment coatings may be applied to the base substrate 32 in the manner described in WO 83/00659.

As shown in FIGS. 1 to 4, the coatings forming the regions 20, 30 are provided in or extend into peripheral areas of the transparent window 18 which is not covered by the layers of opaque plastics material 28. The pigment coatings 20, 30 are preferably partly transparent or translucent so that the peripheral areas of the window covered by the partially opacifying coating allow some light to pass through so that parts 27 of the photographic image 24 which overlie the regions of partial or varying opacity are at least partly visible from both sides of the document in transmission, and visible from only the side on which the photographic image is applied when viewed in reflection. The parts 25 of the photographic image which overlie the layers of completely opaque plastic material 28, 29 are only visible from one side of the document when viewed in reflection or transmission as illustrated by FIGS. 2 and 3.

Preferably, the security document 10 is designed so that the at least one of the coatings, 20, 30 which form the regions of partial or varying opacity would be damaged or removed by an attempt to remove the genuine photographic image 24 and replace it with a substitute photograph. This may be achieved in the embodiment of FIG. 4 by ensuring that the adhesion between the photographic image 24 and the coatings 20, 30 is greater than the adhesion between the coatings 20, 30 and the base substrate 32. Thus any attempt to remove the photographic image 24 will also result in the coatings 20, 30 being removed or damaged, and replacement with a substitute photograph will be detectable by the absence or damage of the regions of partial or varying opacity.

In an alternative embodiment shown in FIG. 5, the photographic image 24 is applied directly to the base substrate 32, e.g. by laser printing, with the coatings 20, 30 forming the regions of partial or varying opacity applied over peripheral areas of the part of the photograph 24 in the transparent window 18. The layers of transparent security laminate 34, 36 are then applied to both sides of the base substrate 32 with the layer 34 covering the photographic image 24 and the coatings 20, 30 forming the regions of partial or varying opacity.

In the embodiment of FIG. 5, the adhesion between the coatings 20, 30 and the photographic image is preferably greater than the adhesion between the security laminate 34 and the coatings 20, 30. Thus any attempt to remove the photographic image 24 will also result in removal or damage of the regions 20, 30 of partial or varying opacity

Referring to FIG. 6, the identity card 10 is formed by an alternative method of production. Rather than printing the photographic image 24 directly onto the base substrate 32, the photographic image 24 is applied on a transparent imaging laminate material which is laminated to the base substrate 32. For ease of reference, identical reference numerals are used to refer to like features of the embodiments of FIGS. 4, 5 and 6. The photographic image 24 may be applied to the imaging laminate 44 via thermal transfer printing. The imaging laminate 44 is applied, e.g. by an adhesive, to the base substrate 32 so that it overlays the regions of partial or varying opacity 20, 30. The security laminates 34 and 36 are then applied to both sides of the base substrate 32, as described above in relation to the embodiments of FIGS. 4 and 5.

In the embodiment of FIG. 6, the adhesion between the imaging laminate 44 and the coatings 20, 30 forming the regions of partial or varying opacity is preferably greater than the adhesion between the coatings 20, 30 and the base substrate 32. Thus, removal of the imaging laminate 44 and photographic image 24 will also cause removal or damage of the coatings 20, 30 which will be detectable in an attempt to replace the photographic image 24 with a substitute photograph on another imaging laminate.

As will be readily apparent to a person skilled in the relevant art, application of the imaging laminate 44 and security laminates 34 and 36 may involve heat and/or pressure to facilitate bonding.

In other possible methods of production (not shown), the coatings 20, 30 forming the regions of partial or varying opacity may be provided on opposite sides of the base substrate 32, or even on opposite sides of the imaging laminate 44 of FIG. 6. In such embodiments removal of the photographic image may result in removal or damage of one of the coatings 20, 30 leaving the other coating present so that tampering by replacement with a substitute photographic image is detectable by the absence of one coating and the presence of another.

It will be appreciated that various modifications and alterations may be made to the preferred embodiments described above without departing from the scope and spirit of the present invention.

1-56. (canceled)

57. A security document or token bearing indicia, wherein the document or token has a transparent region, and a biometric image provided in the transparent region, the biometric image being substantially distinguishable when viewed from both sides of the document.

58. A security document according to claim 57 wherein the biometric image is an image which is unique to a particular person.

59. A security document or token according to claim 58, wherein the biometric image is a fingerprint.

60. A security document or token according to claim 58, wherein the biometric image is a photograph of a person corresponding to the holder of the document or token, the photograph enabling the unique facial structure of the person to be identified and distinguished from both sides of the document or token.

61. A security document or token bearing indicia, wherein the document or token has a transparent region and a photographic image provided in the transparent region, the photographic image being substantially distinguishable when viewed from both sides of the security document, wherein the photographic image is an image of a person's face, the image enabling the unique facial structure of the person to be identified and distinguished from both sides of the document or token.

62. A security document or token according to claim 57, wherein at least the transparent region of the security document or token is formed from a transparent plastics material.

63. A security document or token according to claim 62 comprising a substantially opaque support including a transparent portion forming the transparent region.

64. A security document or token according to claim 62 wherein the document or token includes a transparent substrate of plastics material which is covered by one or more opacifying layers or coatings, except in the area of the transparent region.

65. A security document or token according to claim 64 wherein the transparent substrate is covered by one or more opacifying layers of ink or other pigments.

66. A security document or token according to claim 64 wherein the transparent substrate is covered by one or more layers of stiff material to form a document or token in the form of a card.

67. A security document or token according to claim 64 wherein the transparent substrate comprises a polymeric material.

68. A security document or token according to claim 57 having at least one region of partial or varying opacity adjacent to or surrounding the transparent region.

69. A security document or token according to claim 68 wherein part of the biometric or photographic image extends into said at least one region of partial or varying opacity.

70. A security document or token according to claim 57 wherein part of the biometric or photographic image extends beyond the transparent region into at least one substantially opaque region of the document or token adjacent to or surrounding the transparent region.

71. A security document or token bearing indicia, wherein the document or token has a transparent region, at least one region of partial or varying opacity adjacent to or surrounding the transparent region, and an image provided in the transparent region, the image being substantially distinguishable when viewed from both sides of the document or token, and the image extending into the at least one region of partial or varying opacity.

72. A security document or token according to claim 71 wherein part of the image extends beyond said at least one region of partial or varying opacity into at least one substantially opaque region adjacent to or surrounding said at least one region of partial or varying opacity.

73. A security document or token according to claim 71 wherein said at least one region of partial or varying opacity is formed by at least one partially opacifying pigment coating.

74. A security document or token according to claim 73 wherein different forms of said at least one partially opacifying pigment coating have different proportions of a major portion of pigment in a minor portion of polymeric binder to provide different degrees of opacity for one or more regions of varying opacity.

75. A security document or token according to claim 73 wherein different thicknesses of a partially opacifying pigment coating are applied to form one or more regions of varying opacity.

76. A security document or token according to claim 57 wherein the image comprises a digital image.

77. A security document or token according to claim 57 wherein the image is a printed image.

78. A security document or token according to claim 57 wherein the image is a laser printed image.

79. A security document or token according to claim 57 wherein the image is formed onto an imaging laminate which is bonded to at least the transparent region of the document or token.

80. A security document or token according to claim 71 wherein said at least one region of partial or varying opacity and the image are applied to a support or substrate of the document or token in such a manner that removal of the image from the support or substrate will also result in removal or damage of at least one region of partial or varying opacity.

81. A security document or token according to claim 80 wherein the adhesion between the image and the at least one region of partial or varying opacity is greater than the adhesion between the at least one region of partial or varying opacity and the support or substrate.

82. A security document or token according to claim 80 wherein the image is formed onto an imaging laminate which is bonded to the support or substrate and to the at least one region of partial or varying opacity, and the adhesion between the imaging laminate and the at least one region of partial or varying opacity is greater than the adhesion between the at least one region of partial or varying opacity and the support or substrate.

83. A security document or token according to claim 57 further including at least one security laminate provided on at least one side of the support or substrate on which the image is provided.

84. A security document or token according to claim 83 wherein security laminates are provided on both sides of the support or substrate to encapsulate the image and the support or substrate.

85. A security document or token according to claim 80 wherein the at least one region of partial or varying opacity is applied over the image, a security laminate is applied over the at least one region of partial or varying opacity, and the adhesion between the at least one region of partial or varying opacity and the image is greater than the adhesion between the security laminate and the at least one region of partial or varying opacity.

86. A security document or token according to claim 80 wherein a plurality of regions of partial or varying opacity are provided, and removal of the image results in removal or damage of at least one of the regions of partial or varying opacity and leaving at least one other region of partial or varying opacity present on the support or substrate.

87. A method of forming a security document or token comprising the steps of providing a support with a transparent region, and providing a biometric image in the transparent region, the biometric image being substantially distinguishable when viewed from both sides of the support.

88. A method according to claim 87 wherein the support comprises a substantially opaque substrate, and a transparent portion of plastics material is provided in the substrate to form the transparent region.

89. A method according to claim 87 wherein the support comprises a substrate of transparent plastics material, the method further comprising the step of covering the transparent plastics substrate with one or more opacifying layers except in the area of the transparent region.

90. A method according to claim 87 further comprising the step of applying one or more regions of partial or varying opacity to the support adjacent to or surrounding the transparent region.

91. A method according to claim 90 wherein said one or more regions of partial or varying opacity are applied by at least partially bonding said regions to the support.

92. A method according to claim 90 wherein at least one pigment coating of partial or varying opacity is applied to the support to form the one or more regions of partial or varying opacity.

93. A method according to claim 92 wherein different forms of partially opacifying pigment coatings are applied to the support to provide the one or more regions of partial or varying opacity.

94. A method according to claim 92 wherein at least one partially opacifying pigment coating is applied to different areas of said support in different thicknesses to provide one or more regions of varying opacity.

95. A method according to claim 90 wherein the biometric image is applied in such a manner as to extend partially into said one or more regions of partial or varying opacity.

96. A method of forming a security document or token comprising the steps of providing a support with a transparent region, applying one or more regions of partial or varying opacity to the support adjacent to or surrounding the transparent region, and providing an image in the transparent region, the image being substantially distinguishable when viewed from both sides of the support, and the image extending into the at least one region of partial or varying opacity.

97. A method according to claim 87 further comprising the step of applying the image to extend beyond the transparent region partially into at least one substantially opaque region adjacent to or surrounding the transparent region.

98. A method according to claim 96 further comprising the step of applying the image to extend beyond said one or more regions of partial or varying opacity into at least one substantially opaque region adjacent to or surrounding the one or more regions of partial or varying opacity.

99. A method according to claim 87 further including the step of applying the image directly to the support by printing.

100. A method according to claim 98 wherein the image is applied by laser printing.

101. A method according to claim 87 including the step of applying the image indirectly, via an imaging laminate including the image.

102. A method according to claim 101 wherein the image is applied to the imaging laminate by thermal transfer printing.

103. A method according to claim 101 including the step of bonding the imaging laminate to the support.

104. A method according to claim 96 wherein said at least one region or partial or varying opacity and the image are applied to the support in such a manner that removal of the image from the support will also result in removal or damage of at least one region of partial or varying opacity.

105. A method according to claim 104 wherein the at least one region of partial or varying opacity and the image are applied in such a manner that adhesion between the image and the at least one region of partial or varying opacity is greater than the adhesion between the at least one region of partial or varying opacity and the support.

106. A method according to claim 104 including the steps of forming the image onto an imaging laminate, and bonding the imaging laminate to the support and to the at least one region of partial or varying opacity, wherein the adhesion between the imaging laminate and the at least one region of partial or varying opacity is greater than the adhesion between the at least one region of partial or varying opacity and the support.

107. A method according to claim 87 further including the step of providing at least one security laminate on at least one side of the support on which the image is provided.

108. A method according to claim 107 further including the step of applying security laminates on both sides of the support to encapsulate the image and the support.

109. A method according to claim 104 including the steps of applying the at least one region of partial or varying opacity over the image, applying a security laminate over the at least one region of partial or varying opacity, wherein the adhesion between the at least one region of partial or varying opacity and the image is greater than the adhesion between the security laminate and the at least one region of partial or varying opacity.

110. A method according to claim 104 including the step of providing a plurality of regions of partial or varying opacity, wherein removal of the image results in removal or damage of at least one of said plurality of regions leaving at least one other of said plurality of regions present on the support.

111. A method according to claim 110 including the steps of applying at least one region of partial or varying opacity on one side of the support, and applying at least one other region of partial or varying opacity on the opposite side of the support.

112. A method according to claim 87 or claim 96 wherein the image is a photographic image of a person's face, the image enabling the unique facial structure of the person to be identified and distinguished from both sides of the document.
